(19) United States
(12) Patent Application Publication
(10) Pub. No.: US 2010/0274792 A1
(43) Pub. Date: Oct. 28, 2010

(54) ENHANCED ADDRESS BOOK FOR MOBILE WIRELESS COMMUNICATION DEVICES

(76) Inventor: Ashwini A. BHANGI, Panaji (IN)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 11/619,113

(22) Filed: Jan. 2, 2007

(51) Int. Cl. G06F 17/30

(52) U.S. Cl. 707/754; 707/E17.059; 707/769; 707/E17.014

(57) ABSTRACT

An exemplary method for displaying address book entry data on a mobile wireless communication device comprises displaying a list of contacts entries on a display, receiving first input indicative of selection of one of the contact entries, receiving second input indicative of a request for historical transactions associated with the selected one of the contact entries, and displaying a list of historical transaction associated with the selected one of the contact entries in response to the second input. The method may further include retrieving an entire historical transaction log (e.g., phone call history log or message history log) from memory, and filtering the entire historical transaction log to generate a temporary transaction history. According to one embodiment, the filtering step further comprises ascertaining identification information associated with the selected one of the contact entries, and retrieving entries from the entire historical transaction log which match the ascertained identification information.

### TECHNICAL FIELD

The present invention relates to the field of wireless communication devices. More specifically, the invention relates to an enhanced address book data presentation technique for mobile wireless communication devices.

### BACKGROUND

A typical wireless communication device, such as a mobile phone, comprises, among other things, a processor coupled to a memory and to a transceiver, each enclosed in a housing. A mobile power source, such as a battery, is coupled to and supplies power to the processor, the memory and the transceiver. A speaker and a microphone are also enclosed within the housing for transmitting and receiving, respectively, acoustic signals to and from a user of the wireless communication device. The wireless communication device communicates information by transmitting and receiving electromagnetic (“EM”) energy in the radio frequency (“RF”) band via an antenna coupled to the transceiver.

Mobile phones are typically characterized by their small form factor, making storage and portability convenient for the user. Unfortunately, a mobile phone's small form factor is commonly accompanied by limitations inherent to its physical dimensions, such as reduced memory size, reduced battery life, and reduced input/output (I/O) capabilities, such as reduced keys for input and control. These limitations often result in a device with limited functionality or limited feature sets, reducing the overall user satisfaction. These drawbacks are further aggravated due to the limited flexibility in accessing and presenting data stored on the mobile phone, such as phone address book entry information and related data.

### SUMMARY

Disclosed herein are an enhanced address book data presentation technique and related user interface which address the limitations in conventions mobile phone implementations. According to one embodiment, the method for displaying address book entry data on a mobile wireless communication device including a memory and a display comprises displaying a list of contacts entries on the display, receiving a first input indicative of selection of one of the contact entries, receiving a second input indicative of a request for historical transactions associated with the selected one of the contact entries, and displaying a list of historical transaction associated with the selected one of the contact entries in response to the second input.

In one embodiment, the method further includes retrieving an entire historical transaction log (such as a phone call history log or a message history log) from the memory, and filtering the entire historical transaction log to generate a temporary transaction history associated with the selected one of the contact entries. According to one embodiment, the filtering step further comprises ascertaining identification information associated with the selected one of the contact entries, and retrieving entries from the entire historical transaction log which match the ascertained identification information. By way of illustration, the temporary transaction history can be stored as a table in the memory, or may be a dynamic subset of the entire historical transaction log.

Other features and advantages of the present invention will become more readily apparent to those of ordinary skill in the art after reviewing the following detailed description and accompanying drawings.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1 illustrates an exemplary mobile wireless communication device according to an embodiment of the present invention.

FIG. 2 illustrates exemplary user-interface components of a mobile wireless communication device according to an embodiment of the present invention.

FIGS. 3 through 7 illustrate exemplary screen displays during operation of a mobile wireless communication device according to an embodiment of the present invention.

FIG. 8 is a flow chart illustrating an exemplary address book data presentation method according to an embodiment of the present invention.

### DETAILED DESCRIPTION OF THE INVENTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

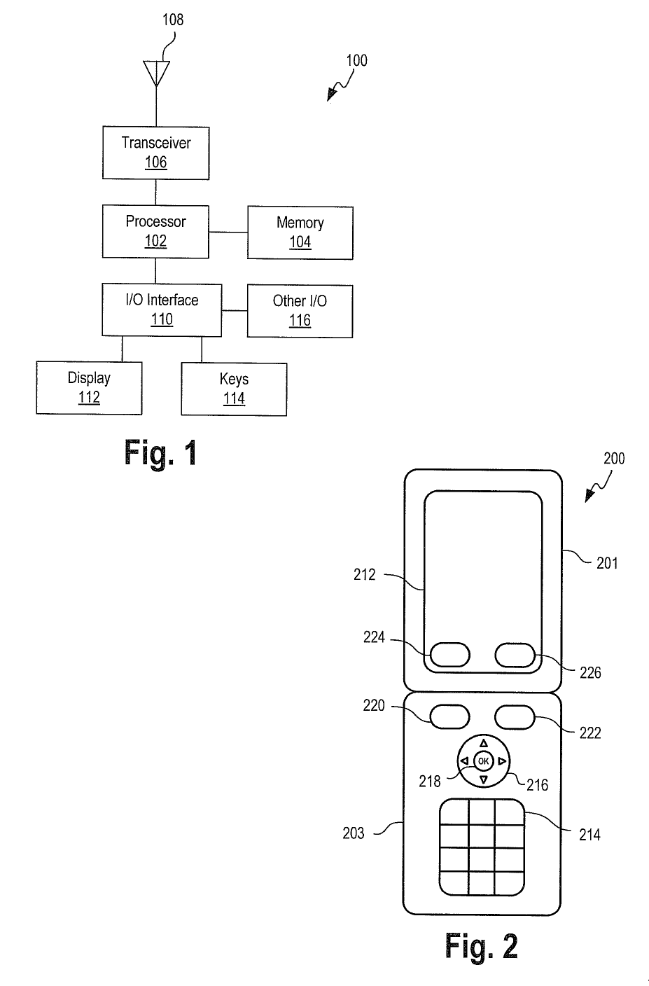

Referring first to FIG. 1, there is shown exemplary mobile wireless communication device 100 according to one embodiment of the present invention. By way of example, wireless communication device 111 may be a mobile phone capable of communicating RF signals in one or more frequency bands.

As shown in FIG. 1, wireless communication device 100 comprises processor 102 coupled to memory 104 and to transceiver 106, each mounted within a housing. A mobile power source (not shown), such as a battery, supplies power to various components of wireless communication device 100. Transceiver 106 is further coupled to antenna 108 for transmission and reception of RF signals. Processor 102 is further coupled input/output (I/O) interface 110 for receiving and/or transmitting data to the user via various I/O devices, such as display 112, input keys 114 and other I/O devices 116, such as a speaker and microphone, for example.

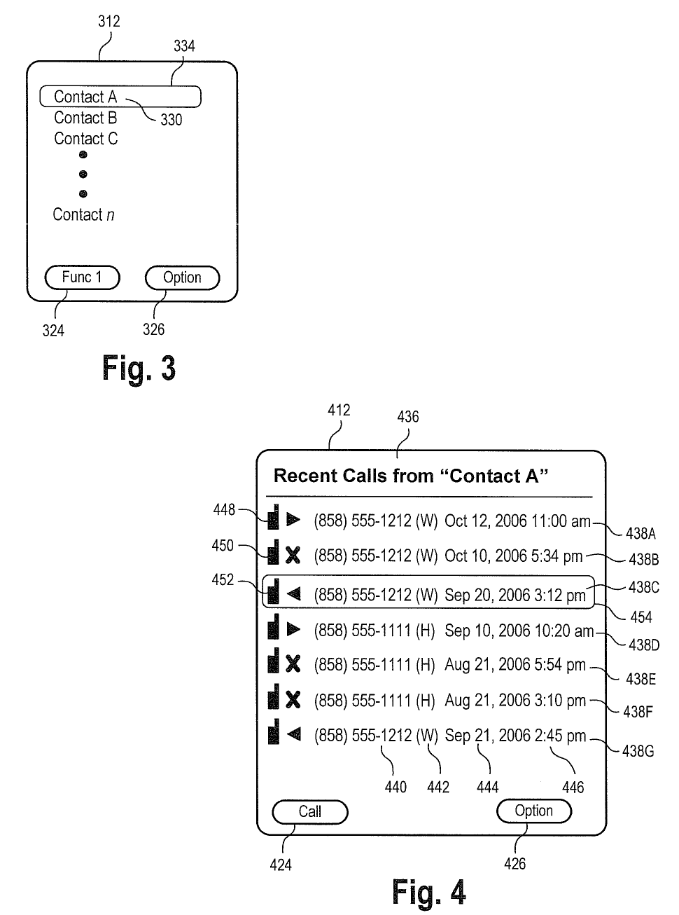

Referring now to FIG. 2, exemplary wireless communication device 200 according to one embodiment of the present invention is shown. In FIG. 2, top and the bottom housing portions of a clamshell arrangement are shown by 201 and 203 respectively. It is noted that the invention may be used with other housing designs, such as slidable-connected housing and bar phone housing, for example. Top housing portion 201 includes display 212. Soft keys 224 and 226 may be displayed on display 212 and can be assigned to one of various executable functions at a time. Bottom housing portion 203 includes numeric keypad 214, navigation keypad 216 along with OK button 218. In the embodiment shown in FIG. 2, key 220 is associated with soft key 224 and the key 222 is associated with soft key 226.

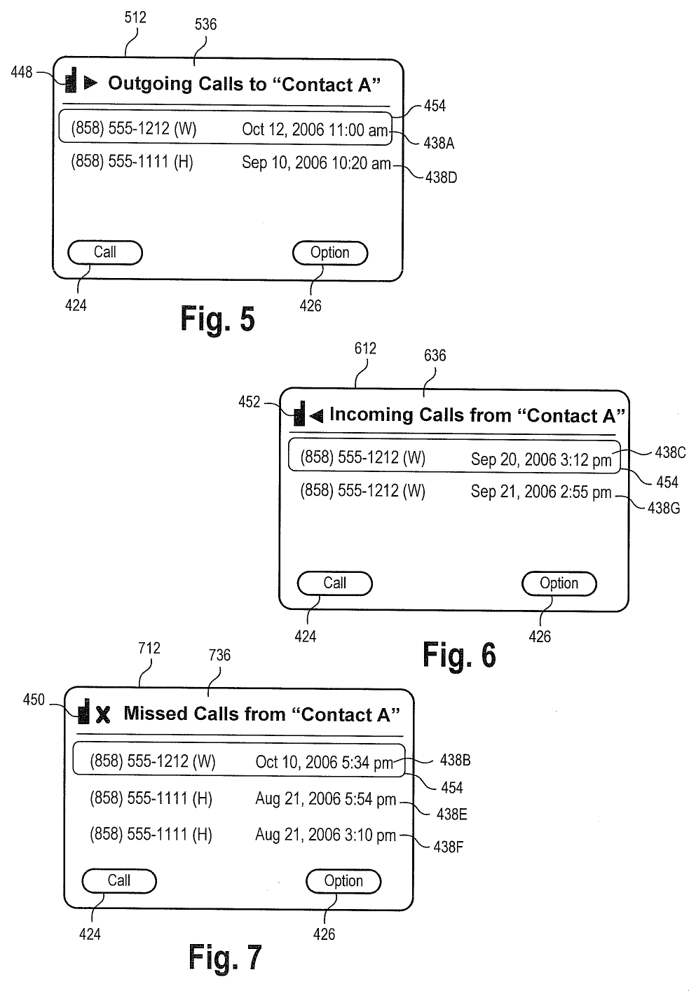

FIGS. 3 through 7 illustrate exemplary screen displays during operation of the mobile communication device 200 according to an embodiment of the present invention. FIG. 3 depicts the screen display 312 of a contact list including a plurality of contacts, such as contact A 330, from an address book stored in the memory of mobile communication device 200. Although not shown, the contact list will typically identify the name of the person or entity associated with each entry. In addition, associated contact information may also be provided, such as address, phone number, email address, for example. The user, using navigation key 216, can scroll or navigate through the individual contacts on the contact list, where the currently selected or navigated contact can be indicated by highlight 334, although other selection indicators may also be used, such as circling, underlining, pointer indicators, or typeface (bold, italics, fonts, colors, etc.) indicators, for example. Other input techniques may also be used for navigating the contact list, such as via voice input, touchscreen, or other keys, such rocker keys, scroll keys, and jog dials, for example.

In screen display 312, soft key 324 is shown associated with “function 1,” and soft key 326 is shown associated with an “option” command. Function 1 can be “call,” “send message,” “delete,” or “view contact,” for example. As discussed above, key 220 of device 200 may be associated with soft key 324 and can be activated by a user of device 200 for invoking “function 1.” The selected function would then be applied to the currently selected or navigated contact from the list.

Similarly, key 222 of device 200 may be associated with soft key 326 and can be activated by a user of device 200 for invoking the “option” command. When the “option” command is invoked, a plurality of functions may be displayed in a list form to the user. Typically, the user, using the navigation key 216, can scroll or navigate the individual items on the list. The current selection can be indicated in any number of ways, e.g., highlighting, circling, underlining, pointer indicator, or typeface (bold, italics, fonts, colors, etc.) indicator. The user can invoke a specific function after selection by activating OK button 218.

According to one embodiment, “view call history” (VCH) is a function that can be associated with the particular selected or navigated contact indicated by highlight 334. VCH may be considered a type of “historical transaction” carried out between device 200 and the particular selected or navigated contact. Other types of historical transactions are discussed below. In the present example, VCH may be invoked by function soft key 324 or via option soft key 326. Other means for invoking VCH may be also implemented, such as via voice input, touchscreen, or other keys, for example.

FIG. 4 illustrates screen display 412 after invoking VCH for a particular contact. Unlike conventional call histories which display calls from all parties, screen display 412 displays only the call history items associated with the particularly selected contact, as indicated by screen title 436. Following screen title 436 are listed a plurality of call history entries associated with the particularly selected contact, such as “Caller A,” for example. In screen display 412, call history items 438A through 438G are shown. The call history items identify information associated with each call history item. In the example shown in FIG. 4, the call history item may identify the phone number 440, indication of the phone number type 442 (“W” for office or work, “H” for home, or “M” for mobile, for example), date 444 and time 446 associated with a previous call transaction. Icons or other indicia or text may also be included to indicate whether the call was incoming 452, outgoing 448 or missed 450. It is noted that the particular information shown for the call history is only illustrative, and thus may vary from that specifically shown in FIG. 4, for example, having fewer or more information.

The user, using navigation key 216, can scroll or navigate through the individual call history items on the list, where the currently selected or navigated call history item can be indicated by highlight 454, although other selection indicators may also be used, such as circling, underlining, pointer indicators, or typeface (bold, italics, fonts, colors, etc.) indicators, for example. Other input techniques may also be used for navigating the call history items, such as via voice input, touchscreen, or other keys, such rocker keys, scroll keys, and jog dials, for example. In this way, the user is able to perform one or more functions associated with the selected call history item. For example, the user is able to initiate a call function to a phone number (e.g., (858) 555-1212) associated with the selected call history item (e.g., 438C), by invoking soft key 424 via key 222 of device 200. Other functions may also be invoked with respect to the selected call history item including delete, sort, or view call details, for example. Viewing call details allows the user to ascertain additional information about that particular call transaction, such as length of call, for example.

The call history entries shown in screen display 412 can also be filtered or sorted according to additional or different criteria. For example, the call history entries can be filtered or limited to display only outgoing calls made to a particular address book entry (e.g., “Contact A”) as shown in screen display 512 of FIG. 5. In the example of FIG. 5, screen display 512 includes screen title 536, and icon 448 may be optionally provided. Following screen title 536, only those call history entries which are outgoing and directed to “Contact A” are listed, namely entries 438A and 438D, corresponding to the same entries from FIG. 4. Similarly, FIG. 6 illustrates screen display 612 corresponding to call history entries received from a particular address book entry (e.g., “Contact A”). Thus, following screen title 636 are listed those call history entries which are incoming and received successfully from “Contact A,” namely entries 438C and 438G, corresponding to the same entries from FIG. 4. Icon 452 may be optionally provided as shown in FIG. 6. As another example, referring to FIG. 7, screen display 712 is shown corresponding to call history entries from a particular address book entry (e.g., “Contact A”) which were missed or unanswered. Accordingly, in screen display 712, following screen title 736 are listed those call history entries which are incoming but missed (unanswered) from “Contact A,” namely entries 438B, 438E and 438F, corresponding to the same entries from FIG. 4. Icon 450 may be optionally provided as shown in FIG. 7.

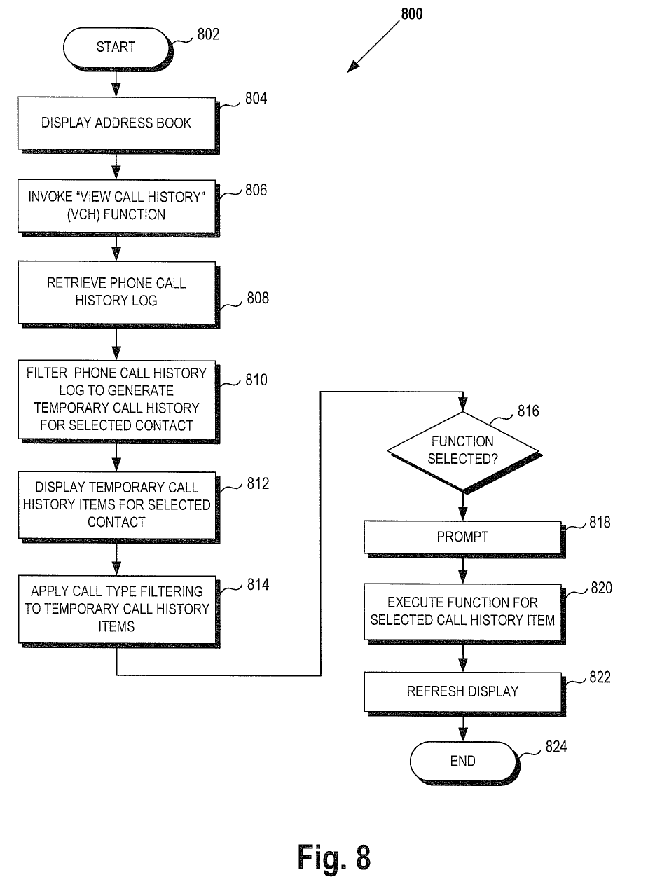

FIG. 8 depicts flowchart 800 for an exemplary method for performing address book data presentation in mobile communication device 200 of FIG. 2 according to one embodiment. The method may be implemented in software code executed by processor 102 as part of or separate from the address book application. Certain details and features have been left out of flow chart 800 of FIG. 8 that are apparent to a person of ordinary skill in the art. For example, a step may consist of one or more sub-steps as known in the art. While steps 802 through 824 shown in flow chart 800 are sufficient to describe one embodiment of the present invention, other embodiments of the invention may utilize steps different from those shown in flow chart 800.

Method 800 begins at step 802, typically when the user invokes the address book application of mobile communication device 200. At step 804, the address book contents are displayed, typically as a list of contacts on display 212. As described above, the contact list will typically identify the name of the person or entity associated with each entry. In addition, associated contact information may also be provided, such as address, phone number, and email address, for example.

At step 806, the user of mobile communication device 200 has invoked the VCH function for a particularly selected or navigated contact entry. VCH function can be invoked by user in a variety of ways, including choosing the function from a menu, as discussed above in conjunction with FIG. 4. In other embodiments, activation of multiple selection mode can be invoked using other techniques, such by activation of a dedicated key, activation via a voice command, selection from an application menu, or by detection of a setting or preference in the memory of the device, for example.

At step 808, in response to the user's invoking the VCH for a selected contact entry, the phone call history log is retrieved from memory. The phone call history log is typically stored for every call transaction carried out by the phone, and is stored in the memory of mobile communication device 200. At step 810, the phone call history log is filtered or queries to generate a temporary call history associated with the particularly selected or navigated contact entry. For example, the temporary call history generated may comprise a list of entries corresponding only to those records from the phone call history log based on matching identification information associated with the particularly selected or navigated contract entry, e.g., where the phone number in the phone call history log matches one or more of the phone numbers associated with the particularly selected or navigated contact entry. By way of illustration, in the example discussed above in conjunction with FIG. 4, the records returned from the phone call history log are those matching Contact A′s work phone number (i.e., (858) 555-1212) and Contact A′s home phone number (i.e., (858) 555-1111) and any other numbers associated with “Contact A”. By way of illustration, the temporary call history may be a table stored in memory containing the record entries pursuant to the filter or query criteria discussed above. In other embodiments, the temporary call history may be a “dynaset” or a dynamic subset of the actual call history log, with only those records displayed which match the filter or query criteria discussed above.

At step 812, a screen display is generated corresponding to the entries generated from the temporary call history, that is, those entries of the phone call history log which correspond to the particularly selected or navigated contact entry. Screen display 412 of FIG. 4 is illustrative of this screen display. One advantage of this view is that user of mobile communication device 200 is able to quickly and easily view the calls associated with a particular contact entry without the clutter of other call information not associated with that same contact entry.

At step 814, the user is able to optionally modify the screen display by specifying a different sort order or by applying additional filtering criteria. For example, the temporary call history entries can be further filtered or limited to display only outgoing calls made to a particular address book entry (e.g., “Contact A”) as shown in FIG. 5, or to display call history entries which are incoming and received successfully from a particular address book entry as shown in FIG. 6, or to display call history entries which were missed or unanswered and originated from a particular address book entry as shown in FIG. 7. In other embodiments, step 814 may be omitted and the method may continue to step 816 without modifying the screen display.

At decision step 816, a determination is made as to whether the user has invoked a function to perform on a “selected” call history entry. As discussed above, the user may select functions by way of soft keys, although other means for invoking functions may also be used, e.g., selection from a menu, voice activation, or dedicated function keys. Exemplary functions that the user may select include, but are not limited to, call and delete.

At step 818, the user may optionally be prompted to confirm that the user would like to execute the requested function on the selected call history entry. In other embodiments, step 818 may be omitted and the method may continue to step 820 without prompting the user.

At step 820, the selected function is carried out for the selected call history entry. For example, if the delete function is selected, the selected call history entry is deleted from the temporary call history and/or the phone call history log.

At step 822, the screen display may be refreshed to show the updated contents of the call history for the particularly selected contact entry. In certain embodiments, step 814 can be repeated following step 822. At step 824, method 800 is concluded.

According to another embodiment of the invention, the technique of displaying and managing call history items for a particularly selected contact entry can also be applied to other historical transactions carried out on mobile communication device 200, such as data call transactions, messaging transactions, and the like. For example, the message history log (a log of text or SMS messages) can be filtered and queried to generate a temporary message history list associated with a particularly selected user for the user's address book. This temporary message history log list can be displayed to the user via a screen display similar to that described above for phone call transactions, and the user is able to invoke commands or functions, e.g., view message, send reply or delete, associated with those temporary message history list entries.

The present invention further relates to machine readable media on which are stored embodiments of the present invention. It is contemplated that any media suitable for storing instructions is within the scope of the present invention. By way of example, such media may take the form of magnetic, optical, or semiconductor media. The invention also relates to data structures that contain embodiments of the present invention, and to the transmission of data structures containing embodiments of the present invention.

From the above description of exemplary embodiments of the invention, it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described exemplary embodiments are to be considered in all respects as illustrative and not restrictive. It should also be understood that the invention is not limited to the particular exemplary embodiments described herein, but is capable of many rearrangements, modifications, and substitutions without departing from the scope of the invention.

What is claimed is:

1. A method for displaying address book entry data on a mobile wireless communication device including a memory and a display, the method comprising:
displaying a list of contacts entries on the display;
receiving a first input indicative of selection of one of the contact entries;
receiving a second input indicative of a request for historical transactions associated with the selected one of the contact entries;
retrieving an historical transaction log from the memory;
filtering the historical transaction log to generate a temporary transaction history associated with the selected one of the contact entries;
storing the temporary transaction history as a table in the memory;
receiving a third input indicative of an additional filter criteria associated with the selected one of the contact entries, the third input selected from the filter criteria group consisting of an outgoing call associated with a particular address, a received call associated with the particular address, and a missed call associated with the particular address;
applying the additional filter criteria to the temporary transaction history associated with the selected one of the contact entries;
displaying a filtered list of historical transactions associated with the selected one of the contact entries in response to the second input;
receiving a fourth input indicative of a delete function to be executed on the selected contact entry of the temporary transaction history; and
deleting the one entry of the temporary transaction history from the temporary transaction history.

2. (canceled)

3. The method of claim 1 wherein the filtering further comprises:
ascertaining identification information associated with the selected one of the contact entries; and
retrieving entries from the historical transaction log which match the ascertained identification information.

4. (canceled)

5. The method of claim 1 wherein the temporary transaction history is a dynamic subset of the historical transaction log.

6. The method of claim 1 wherein the historical transaction log comprises a phone call history log.

7. The method of claim 1 wherein the historical transaction log comprises a message history log.

8. (canceled)

9. (canceled)

10. A mobile wireless communication device comprising:
a processor;
a memory coupled to the processor;
a transceiver coupled to the processor;
an antenna coupled to the transceiver, the memory storing a program of instructions executable by the processor to perform a method for displaying address book entry data, the method including:
displaying a list of contacts entries on the display;
receiving a first input indicative of selection of one of the contact entries;
receiving a second input indicative of a request for historical transactions associated with the selected one of the contact entries;
retrieving an historical transaction log from the memory;
filtering the historical transaction log to generate a temporary transaction history associated with the selected one of the contact entries;
storing the temporary transaction history as a table in the memory;
receiving a third input indicative of an additional filter criteria associated with the selected one of the contact entries, the third input selected from the filter criteria group consisting of an outgoing call associated with a particular address, a received call associated with the particular address, and a missed call associated with the particular address;
applying the additional filter criteria to the temporary transaction history associated with the selected one of the contact entries;
displaying a filtered list of historical transactions associated with the selected one of the contact entries in response to the second input;
receiving a fourth input indicative of a delete function to be executed on the selected contact entry of the temporary transaction history; and
deleting the one entry of the temporary transaction history from the temporary transaction history.

11. (canceled)

12. The device of claim 10 wherein the filtering further comprises:
ascertaining identification information associated with the selected one of the contact entries; and
retrieving entries from the historical transaction log which match the ascertained identification information.

13. (canceled)

14. The device of claim 10 wherein the temporary transaction history is a dynamic subset of the historical transaction log.

15. The device of claim 10 wherein the historical transaction log comprises a phone call history log.

16. The device of claim 10 wherein the historical transaction log comprises a message history log.

17. (canceled)

18. (canceled)
